(19) United States
(12) Patent Application Publication
(10) Pub. No.: US 2004/0067297 A1
(43) Pub. Date: Apr. 8, 2004

(54) Method and apparatus for sterol removal

(76) Inventor: Cecil T. Massie, Bloomington, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/372,010

(22) Filed: Feb. 21, 2003

Related U.S. Application Data
(60) Provisional application No. 60/358,963, filed on Feb. 22, 2002.

(51) Int. Cl. A23D 7/00

(52) U.S. Cl. 426/601

(57) ABSTRACT

A continuous, high efficiency process for reducing sterol content in triglyceride oil by the steps providing a shell containing a support surface. The shell further includes an oil inlet of triglyceride oil and an oil outlet receiving oil from the second end of the support surface, as well as a steam inlet, a steam outlet and an upward directed steam flow. The triglyceride oil is driven upward on the support surface with the upward directed steam flow as a rising turbulent film. Then, the sterol is allowed to transfer from the rising turbulent film of triglyceride oil to the flow of steam. Preferably, the support surface is a tube or tubes which are vertically oriented. The triglyceride oil from the process has a sterol content below about 0.030% or even below about 0.018%.

### RELATED APPLICATION

Priority is claimed from U.S. Provisional Application Serial No. 60/358,963 filed Feb. 22, 2002, the entire disclosure of which is hereby incorporated by reference herein.

### FIELD OF THE INVENTION

The present invention relates generally to sterol removal and, in particular, relates to an improved method of separation of sterol, especially cholesterol from edible triglyceride oils.

### BACKGROUND OF THE INVENTION

The purpose of this invention is to provide an improved process for sterol removal from edible oils. The present invention has certain objectives: (1) to achieve a lower residual sterol content than the currently available technology is capable of achieving, and/or (2) to achieve a low residual sterol content more efficiently than the currently employed technology. The primary approach of the present invention to achieve such a purpose and objectives by employing thin film distillation in a co-current orientation.

The medical, public health, and commercial significance of the desired products resulting from the present invention may be appreciated as follows. Developments arising out of research at Brandeis University demonstrated significant and unexpected interactions between edible oils stripped of sterol content and the aggregate fatty acid profile of blends of cholesterol removed from animal fats and vegetable oils. In particular it was found that oxidative stability was enhanced appreciably by sterol removal from the animal fat fraction. Further, it was found that such blends produced an unexpected and beneficial effect on serum lipid composition when incorporated in the diet. This promising line of inquiry has led to renewed interest in triglyceride oils with eliminated or at least greatly reduced sterol content.

A primary purpose of this invention is the production of triglyceride oils containing negligible levels of sterols. By “negligible” herein is meant less than about 2 mg sterol/13 g of triglyceride. Such a level is generally consistent with information available from the FDA. More specifically, for dietary purposes, the FDA has determined that oils containing less than 2 milligrams of cholesterol per 13 grams have negligible cholesterol content. This translates to a level of about 0.015% by weight for undiluted fats. However, the beneficial effects of reduced serum cholesterol used in the Brandeis research have been observed with levels up to twice that level. Therefore, one target of this invention is a sterol content below about 0.030%. In other words, it is a further object of the present invention to provide a method of removing or reducing the sterol content of an edible oil to or below a level or concentration considered negligible when fed to test subjects. In particular, a “negligible” cholesterol content is preferred in the product of the method, more preferably a sterol content less that about 0.030% by weight, and most preferably, a sterol content of less than about 0.015% by weight.

For the Brandeis University studies to have occurred, the triglyceride oils with reduced sterol content were available. The removal of sterols from edible oils by distillation is a known process and in particular the removal of cholesterol from animal fats has been advanced through the work and disclosures of Marschner et al. in U.S. Pat. Nos. 4,804,555 and 4,996,072, both of which are incorporated by reference herein in their entirety. The Marschner et al. patents disclose the successful removal of cholesterol from edible oils by counter current steam distillation at reduced pressures using a disk and donut distillation column. The Marschner et al. process has been scaled to commercial operation and represents the most commercially successful sterol removal technology to date. However, as explained further below, the product of the Marschner et al. process is relatively expensive due to a capital intensive requirement for the particular counter-current distillation apparatus employed and the need to operate the apparatus at surprisingly low capacity. More specifically, the disk and donut distillation column employed in Marschner et al., as was earlier disclosed in the patents of Artisan Industries, is an expensive and complex apparatus which losses its ability to perform acceptably at high film thickness and overall loading. (See U.S. Pat. Nos. 3,198,241; 3,393,133; and 3,620,283, each of which are also incorporated by reference herein in their entirety).

While the steam distillation process of Marschner and its descendants has proven commercially successful, it does suffer some limitations that have impeded its widespread utilization. One limitation is that the process has proven to be capital intensive and quite difficult and expensive to scale up. The large capital requirement has tended to discourage development of new products from research of the type involved in the Brandeis University studies. Part of the capital intensity is related to the geometry of the column itself. In order to minimize the pressure drop across the column, there must be a large spacing between trays to allow the gas phase to flow with a minimum of resistance. As a result, the height of the distillation column increases rapidly and the structural steel and other support equipment become very expensive, thereby adding appreciably to the capital cost of the project.

The following patents are illustrative of the background upon which the present invention is a significant advance. These patents are hereby incorporated by reference in there entirety: U.S. Pat. No. 4,211,610; U.S. Pat. No. 4,804,055; U.S. Pat. No. 4,996,072; U.S. Pat. No. 3,198,241; U.S. Pat. No. 3,393,133; and U.S. Pat. No. 3,620,283. Additionally, Canadian Patent 873,859 is of interest and is incorporated by reference herein.

Unless otherwise indicated, all documents mentioned herein are hereby incorporated by reference in their entirety. In case of conflict with any of the documents mentioned and incorporated herein, the present specification will control. The materials, methods and examples presented herein are illustrative only and are not intended to be limiting to the present invention.

### SUMMARY OF THE INVENTION

The objectives of this invention are to remove sterols from edible oils by steam distillation in a process that is capital efficient and without increased operating costs. To achieve this objective, the inventor disregarded a generally accepted tenet of separation technology, in particular, that counter current flow is more efficient than co-current flow. Having disregarded this tenet, the inventor has quite unexpectedly found that, in the peculiar case of sterol removal, more efficient steam use is achieved when the steam/oil flow is co-current rather than counter current in orientation.

The present invention, in a first embodiment, is a continuous, high efficiency process for reducing sterol content in triglyceride oils. The process includes the steps of providing a shell containing a support surface. The support surface extends between a first end and a second end, the second end being situated above the first end, the first end of the support surface contacting a supply of triglyceride oil containing sterol. The shell further includes an oil inlet in fluid communication with the supply of triglyceride oil and also includes an oil outlet receiving oil from the second end of the support surface, as well as a steam inlet, a steam outlet and an upward directed steam flow. In the second step, the triglyceride oil is driven upward on the support surface with the upward directed steam flow as a rising turbulent film. And, in the third step, the sterol is allowed to transfer from the rising turbulent film of triglyceride oil to the flow of steam. Preferably, the rising turbulent film on the support surface of the shell is subject to pressure of from about 1 mm Hg to about 23 mm Hg. Also preferably, the rising turbulent film on the support surface in the shell is subject to pressure of from about 1 mm Hg to about 10 mm Hg. Preferably, the rising turbulent film on the support surface in the shell is subject to temperature of from about 375° F. to about 550° F.; and, even more preferably, the rising turbulent film on the support surface in the shell is subject to temperature of from about 500° F. to about 550° F. Preferably, the support surface is a tube; and even more preferably, the tube is substantially vertically oriented. Preferably, the tube is one of a plurality of parallel tubes within a shell. Preferably, the tube has a diameter of about ½ inch. Preferably, the tube has a length of up to about 6 feet.

Moreover, it is preferred that the support surface further includes a liquid separator at the second end to receive the rising turbulent film of triglyceride oil. Preferably, the support surface is one of a plurality of sequentially staged support surfaces, with subsequent sequentially staged support surfaces receiving a supply of triglyceride oil from previous sequentially staged support surfaces, such that the sterol content is progressively reduced by passage as a rising turbulent film over the sequentially staged support surfaces. Preferably, the triglyceride oil resulting from the process has a sterol content below about 0.030%; and more preferably below about 0.018%.

Preferably, the process also includes steps of providing a cooler for cooling the triglyceride oil after transferring sterol to the flow of steam; and, cooling the triglyceride oil in the cooler prior to the oil outlet. Preferably, the process also includes steps of providing a heater for heating the triglyceride oil prior to transferring sterol to the flow of steam; and, heating the triglyceride oil in the heater. In performing the process, it is also preferred that the steam flow and triglyceride oil are present in a ratio of from about 0.5% to about 7.5%.

The present invention is also a process for the removal of sterol from a triglyceride oil to a level below about 0.030% by weight through performance of steps of metering sterol containing triglyceride oil into a chamber operating at pressures from about 1 to 23 mm Hg absolute; heating the triglyceride oil to distillation temperature; mixing the triglyceride oil with steam at a ratio from about 0.5% to about 7.5% of the triglyceride oil weight; propelling the triglyceride oil/steam mixture through a contactor, the contactor including a surface member, wherein the surface member is selected from the group consisting of: a vertical tube and a plate, such that a rising thin film regime is the predominate flow pattern in the resulting rising thin film of triglyceride oil; separating the triglyceride oil from the steam phase and returning the triglyceride oil phase to a subsequent contactor; and cooling the triglyceride oil to exit temperature under system pressure and pumping the triglyceride oil from the process chamber. Preferably, in this process, the contactor tubes are a shell and tube heat exchanger. Preferably, the contactor is configured as described in U.S. Pat. No. 4,211,610. Preferably, the heating step precedes contact with steam and/or the heating step occurs simultaneously with the mixing step of triglyceride oil and steam. Most preferably, the process is continued until the sterol content of the triglyceride oil is less than about 0.018%.

While not wishing to be bound by theory, the inventor explains and suggests that the surprising effectiveness of the present invention may perhaps be understood as most likely due to a previously unappreciated or unrecognized dominating factor of diffusion rates associated with sterols, such as cholesterol, when present in triglyceride oils. That is, the Marschner et al. disclosed process is probably mostly laminar flow on the trays and freshly reforms a thin substantially laminar falling film at each plate of the distillation. Although the reformation of new films between each plate helps to overcome diffusion problems, such was only barely adequate to compensate for the diffusion difficulties associated with the cholesterol in oil, and therefore, limited the process to very low efficiency and/or very low capacity, relative to that throughput capacity which might be expected. In contrast, the co-current flow approach of the present invention is likely substantially more turbulent in flow than the presumably substantially laminar falling film. The turbulence is most probably due to employing the steam flow to drive or propel the film through the apparatus. Such an explanation would also appear consistent with the observation of Marschner et al., viz, that falling counter-current distillation works best when an extremely thin film was present and that effectiveness dropped off when the film thickness increased during attempts to increase throughput.

Previous inventions, such as those of Marschner et al., have shown that sterol removal is best accomplished when the oil is in a thin film. The Marschner et al. disclosure speculates that the extremely thin film formed when the flow rate through the column is reduced well below the nominal fluid capacity rating of the manufacturer is also a likely source of the unexpected success in cholesterol removal. As a practical matter, the flow of the oil across the surface of the plates in Marschner et al. is either in or near a laminar flow regime. In practice it has been found that cholesterol resists migration through the film and it is necessary to mechanically agitate the film. In the case of the Artisan column, this is achieved by breaking the continuity of the film and reforming the film on multiple plates. In the present invention, the concept of breaking and reforming the film is paired with a rising thin film that is mechanically agitated by the rapidly flowing steam. As a result, a dramatic improvement in tray efficiency is achieved. For example, in the Artisan column a disk and donut tray will achieve 5 to 10% tray efficiency while a rising film of the present invention will achieve 40 to 50% tray efficiency.

Tray efficiency in this case is calculated on the basis of the ideal gas law and the approximate vapor pressure of sterols. In the temperature range of this invention, sterols will exhibit a vapor pressure from about 1 to 10 mm mercury. The saturation partial pressure may be estimated using Raoult's law, that is, theoretical saturation at the partial pressure above the mixture is equal to the vapor pressure of the pure substance multiplied by the mole fraction in the liquid phase. What is shown in this invention is that the partial pressure of the sterol in the vapor phase will be in the range of 40 to 50% of the theoretical saturation vapor pressure.

A suitable apparatus for performing the present invention is disclosed in the McGowan patent, U.S. Pat. No. 4,211,610, incorporated by reference herein. McGowan explained his deodorizer invention as a heat and mass transfer apparatus in which a vertically extending conduit defines an upward flow path for a mixture of vapor and liquid. In the McGowan deodorizer, steam is injected into edible oil or fat and causes it to follow an extended, serpentine flow path. Since the deodorizer is operated at sub-atmospheric pressure, the steam expansion is large and promotes efficient heat and mass transfer.

Based upon the above explanation, the present invention in a first embodiment may be understood as a process including the steps of (1) Metering a sterol containing oil and steam into a mixing device attached to a vertically configured or horizontally configured tube or other surface under vacuum. As the steam expands into the vacuum, the oil is propelled along the surface of the tube. (2) Separation of the steam and oil phases after the contacting tube allowing the steam and evaporated oil fractions to pass out to the distillate recovery while the oil fraction falls by gravity or is pumped into the next contactor. (3) Repeating steps one and two above until the desired sterol content is reached. Preferably, care must be also taken in the selection of the steam and oil ratio to assure that a two-phase flow with the oil phase in thin film is the predominate flow regime. If the steam flow rate is excessive, the oil will be dispersed as an aerosol and the necessary agitation of the oil phase to bring sterols to the interface will not occur. An aggregate steam to oil ratio from about 0.5% to 7.5% (weight of steam to weight of oil) is acceptable.

Process Details—Temperature

Distillation temperature is recognized as an important variant in distillation. Appreciable sterol removal occurs at temperatures above 375° F. and increases rapidly above temperatures of about 500° F. Temperatures above 550° F. are generally damaging to the triglycerides and should be avoided. In other words, process operating temperature is preferably above about 375° F., more preferably above about 500° F.; and preferably should not exceed about 550° F.

Process Details—Pressure

System pressure is also a key process variant. Sterol removal at pressures from about 23 mm Hg to 1 mm Hg can be used, depending on other process parameters e.g., temperature. The most useful range is typically from about 1 mm Hg to 10 mm Hg. In other words, the pressure is preferably from about 23 mm Hg to about 1 mm Hg, and more preferably from about 10 mm Hg to about 1 mm Hg.

In another embodiment, the present invention is a continuous, high efficiency process for reducing sterol content in triglyceride oil. The process includes the steps of: (1) providing a shell containing a support surface, the support surface extending between a first end and a second end, the second end being situated above the first end, the first end of the support surface contacting a supply of triglyceride oil containing sterol, the shell further including an oil inlet in fluid communication with the supply of triglyceride oil and an oil outlet receiving oil from the second end of the support surface, a steam inlet, a steam outlet and an upward directed steam flow; (2) driving the triglyceride oil upward on the support surface with the upward directed steam flow as a rising turbulent film; and, (3) allowing sterol to transfer from the rising turbulent film of triglyceride oil to the flow of steam.

Preferably, the process is carried out such that the rising turbulent film on the support surface in the shell is subject to pressure of from about 1 mm Hg to about 23 mm Hg, more preferably pressure of from about 1 mm Hg to about 10 mm Hg. Preferably, the rising turbulent film on the support surface in the shell is subject to temperature of from about 375° F. to about 550° F., more preferably a temperature of from about 500° F. to about 550° F. Preferably, the support surface is a tube, more preferably the tube is substantially vertically oriented, and most preferably, the tube is one of a plurality of substantially parallel tubes within a shell. For larger scale production, the tubes preferably have a diameter of about ½ inch and/or the tubes have a length of up to about 6 feet. Preferably, the support surface further includes a liquid separator at the second end to receive the rising turbulent film of triglyceride oil.

Preferably, the support surface is one of a plurality of sequentially staged support surfaces, with subsequent sequentially staged support surfaces receiving a supply of triglyceride oil from previous sequentially staged support surfaces, such that the sterol content is progressively reduced by passage as a rising turbulent film over the sequentially staged support surfaces. The process of the present invention can produce triglyceride oil resulting from the process with a sterol content below about 0.030% and even a sterol content below about 0.018%, and even triglyceride oil resulting from the process with a sterol content below about 0.015%. Preferably a cooler is provided for the oil and also a heater may be provided or the oil may be heated by the initial contact with the steam flow. In the present invention, it is preferred that the steam flow and triglyceride oil are present in a ratio of from about 0.5% to about 7.5%.

### BRIEF DESCRIPTION OF THE DRAWINGS

FIG. 1 is a schematic of the apparatus and associated material flow of the present invention.

### DETAILED DESCRIPTION OF THE PREFFERED EMBODIMENTS

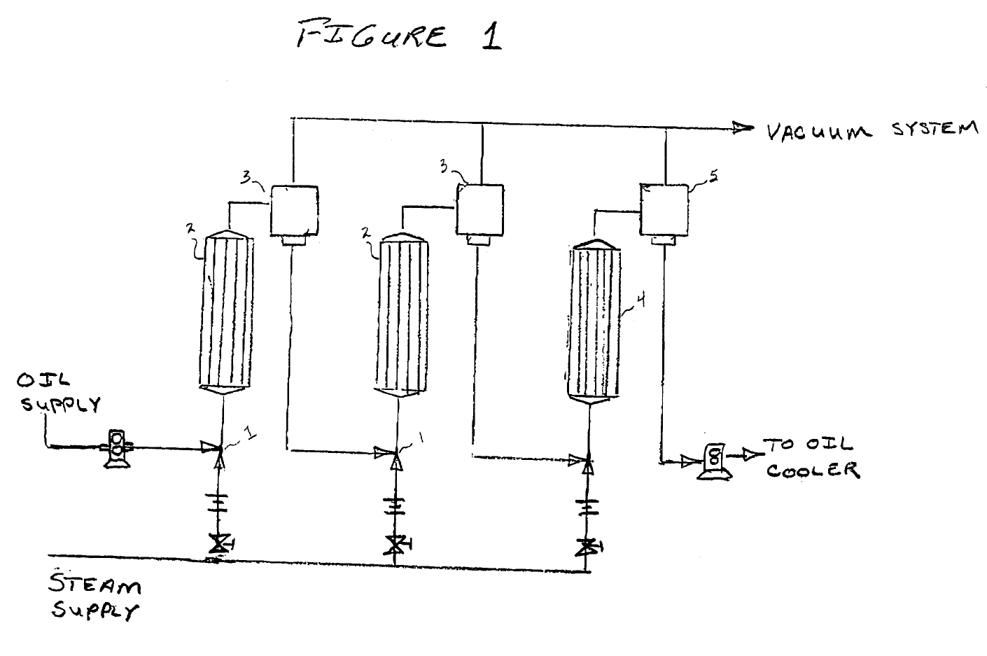

FIG. 1 shows one version of the invention. Sterol containing oil is metered into a mixing tee (1) where steam is injected and mixed with the oil. Since the top end of the contactor (2) is under vacuum, the steam will then propel the steam/oil mixture rapidly through the contactor (2) as a rising thin film to the liquid separator (3). The process is repeated through multiple stages as required to achieve the desired sterol removal. Finally the oil passes through a final contactor (4) jacketed with cooling media and then to a final separator (5) before being pumped out of the vacuum region.

The contactors described in FIG. 1 are suitable for small quantities. However, for larger production, parallel tubes are desirable. Tubes of ½ inch in diameter and up to 6 feet long are suitable for this application. Remarkably, given the wide array of equipment for oil distillation on the market, a simple shell and tube heat exchanger has been found to be most suitable for sterol distillation.

A distillation unit comprised of stages similar to those described in U.S. Pat. No. 4,211,610 is suitable for sterol distillation provided it is operated in the rising thin film range with the steam/oil ratios necessary.

### EXAMPLES

### Example 1

An edible oil containing approximately 80 milligrams of sterols per 100 grams of oil is fed to a deodorizer as described in the McGowan invention at flow rates of steam and oil such that at each contacting stage the steam to oil ratio is within the range of 0.5% to 7.5% and at rates such that in aggregate the total stripping steam used is about 1.4 pounds of steam per pound of edible oil. The final sterol content of the edible oil is 14 milligrams per 100 grams of oil. Pressure in the system is maintained at less than 5 mm mercury absolute while the temperature is maintained at about 510° F.

Because numerous modifications of the present invention may be made without departing from the spirit and scope thereof, the scope of the invention is to be determined by the appended claims and their equivalents.

What is claimed is:

1. A continuous, high efficiency process for reducing sterol content in triglyceride oil comprising the steps of:
providing a shell containing a support surface, the support surface extending between a first end and a second end, the second end being situated above the first end, the first end of the support surface contacting a supply of triglyceride oil containing sterol, the shell further including an oil inlet in fluid communication with the supply of triglyceride oil and an oil outlet receiving oil from the second end of the support surface, a steam inlet, a steam outlet and an upward directed steam flow;
driving the triglyceride oil upward on the support surface with the upward directed steam flow as a rising turbulent film; and,
allowing sterol to transfer from the rising turbulent film of triglyceride oil to the flow of steam.

2. The process of claim 1 and wherein the rising turbulent film on the support surface in the shell is subject to pressure of from about 1 mm Hg to about 23 mm Hg.

3. The process of claim 1 and wherein the rising turbulent film on the support surface in the shell is subject to pressure of from about 1 mm Hg to about 10 mm Hg.

4. The process of claim 1 and wherein the rising turbulent film on the support surface in the shell is subject to temperature of from about 375° F. to about 550° F.

5. The process of claim 1 and wherein the rising turbulent film on the support surface in the shell is subject to temperature of from about 500° F. to about 550° F.

6. The process of claim 1 and wherein the support surface is a tube.

7. The process of claim 6 and wherein the tube is substantially vertically oriented.

8. The process of claim 6 and wherein the tube is one of a plurality of parallel tubes within a shell.

9. The process of claim 6 and wherein the tube has a diameter of about ½ inch.

10. The process of claim 6 and wherein the tube has a length of up to about 6 feet.

11. The process of claim 1 and wherein the support surface further includes a liquid separator at the second end to receive the rising turbulent film of triglyceride oil.

12. The process of claim 1 and wherein the support surface is one of a plurality of sequentially staged support surfaces, with subsequent sequentially staged support surfaces receiving a supply of triglyceride oil from previous sequentially staged support surfaces, such that the sterol content is progressively reduced by passage as a rising turbulent film over the sequentially staged support surfaces.

13. The process of claim 12 and wherein the triglyceride oil resulting from the process has a sterol content below about 0.030%.

14. The process of claim 12 and wherein the triglyceride oil resulting from the process has a sterol content below about 0.018%.

15. The process of claim 12 and wherein the triglyceride oil resulting from the process has a sterol content below about 0.015%.

16. The process of claim 12 and further comprising the steps of:
providing a cooler for cooling the triglyceride oil after transferring sterol to the flow of steam; and,
cooling the triglyceride oil in the cooler prior to the oil outlet.

17. The process of claim 12 and further comprising the steps of:
providing a heater for heating the triglyceride oil prior to transferring sterol to the flow of steam; and,
heating the triglyceride oil in the heater.

18. The process of claim 1 and wherein the steam flow and triglyceride oil are present in a ratio of from about 0.5% to about 7.5%.

19. A process for the removal of sterol from a triglyceride oil to a level below 0.030% by weight comprised of the following steps:
a. metering sterol containing triglyceride oil into a chamber operating at pressures from 1 to 23 mm Hg absolute;
b. heating the triglyceride oil to distillation temperature;
c. mixing the triglyceride oil with steam at a ratio from about 0.5% to about 7.5% of the triglyceride oil weight;
d. propelling the triglyceride oil/steam mixture through a contactor, the contactor including a surface member, wherein the surface member is selected from the group consisting of: vertical tube, and plate, such that a rising thin film regime is the predominate flow pattern in the resulting rising thin film of triglyceride oil;
e. separating the triglyceride oil from the steam phase and returning the triglyceride oil phase to a subsequent contactor; and
f. cooling the triglyceride oil to exit temperature under system pressure and pumping the triglyceride oil from the process chamber.

20. The process of claim 19 and wherein the contactor tubes are a shell and tube heat exchanger.

21. The process of claim 19 and wherein the contactor is configured as described in U.S. Pat. No. 4,211,610.

22. The process of claim 19 and wherein the contactor is comprised of a combination of shell and tube heat exchangers and contactors as described in U.S. Pat. No. 4,211,610.

23. The process of claim 19 and wherein the heating step precedes contact with steam.

24. The process of claim 19 and wherein the heating step occurs simultaneously with the mixing step of triglyceride oil and steam.

25. The process of claim 19 and wherein the process is continued until the sterol content of the triglyceride oil is less than 0.018%.
